(19) United States
(12) Patent Application Publication
(10) Pub. No.: US 2026/0187768 A1
(43) Pub. Date: Jul. 2, 2026

(54) METHODS AND SYSTEMS FOR CHROMATIC ABERRATION COMPENSATION IN DUAL-WAVELENGTH DIGITAL HOLOGRAPHY

(71) Applicant: SOUTH CHINA NORMAL UNIVERSITY, Guangzhou (CN)

(72) Inventors: Xiaoxu LYU, Guangzhou (CN); Zhengyang BU, Guangzhou (CN); Xilong WU, Guangzhou (CN)

(73) Assignee: SOUTH CHINA NORMAL UNIVERSITY, Guangzhou (CN)

(21) Appl. No.: 19/437,178

(22) Filed: Dec. 30, 2025

(30) Foreign Application Priority Data
Dec. 30, 2024 (CN) 202411970669.3

(51) Int. Cl. G06T 5/80; G03H 1/04; G06T 5/10; G06T 17/00

(52) U.S. Cl. CPC G06T 5/80; G03H 1/0443; G06T 5/10; G06T 17/00; G03H 2222/13; G03H 2223/24; G03H 2226/02; G06T 2207/20056

(57) ABSTRACT

A method for chromatic aberration compensation in dual-wavelength digital holography is provided. The method includes: obtaining a dual-wavelength interferogram simultaneously containing two wavelengths; obtaining complex amplitudes of the two different wavelengths at a camera plane; performing numerical propagation on object wavefronts of the two wavelengths within a defocus range to obtain complex amplitudes of the two wavelengths at different axial propagation positions within the defocus range using an angular spectrum method; calculating single-wavelength phase distributions corresponding to the axial propagation positions within the defocus range; calculating, for all combinations of different axial propagation positions for the two wavelengths, dual-wavelength synthetic phase distributions; obtaining a chromatic-aberration-compensated dual-wavelength synthetic phase by identifying a combination of optimal axial propagation positions at which the gradient value of the corresponding dual-wavelength synthetic phase distribution reaches a minimum, and subtracting two single-wavelength phases corresponding to the identified axial propagation positions.

### CROSS-REFERENCE TO RELATED APPLICATIONS

This application claims priority to the Chinese Patent Application No. 202411970669.3, filed on Dec. 30, 2024, the contents of which are hereby incorporated by reference.

### TECHNICAL FIELD

The present disclosure generally relates to a field of digital holography three-dimensional measurement, and in particular to a method and a system for chromatic aberration compensation in dual-wavelength digital holography.

### BACKGROUND

With the development of the precision manufacturing industry, three-dimensional (3D) morphology measurement is required for objects such as Micro-Electro-Mechanical System (MEMS) devices and semiconductor chips, whose surface height variations range from several hundred nanometers to several hundred micrometers. Existing digital holography utilizes the principle of interference to measure the optical phase of light waves modulated by an object, thereby obtaining 3D information of the object. Digital holography offers advantages such as high precision, non-contact and non-destructive measurement, non-intervention, ease of use, no need for staining biological samples, and compatibility with other instruments. Dual-wavelength digital holography builds upon digital holography by employing two light waves of different wavelengths to perform interferometric measurements through wavelength synthesis, significantly extending the measurement range of interferometry. Dual-wavelength digital holography finds wide applications in MEMS inspection and biomedical detection.

However, dual-wavelength digital holography requires recording a set of interferograms of two wavelengths for microscopic phase measurement of a sample. Due to the dispersion characteristics of optical components themselves, chromatic aberration occurs when two wavelengths are imaged on the same plane. That is to say, in the interferograms of the two wavelengths obtained on one camera plane, only the object wavefront of one wavelength is actually in focus, while the object wavefront of the other wavelength is in a defocused state. Therefore, the defocused phase images calculated from the interferograms of the two wavelengths introduce errors into the dual-wavelength synthetic phase measurement.

To solve the chromatic aberration problem, the present disclosure provides a method and a system for chromatic aberration compensation in dual-wavelength digital holography. The method and the system enable the simultaneous capture of off-axis spatial carrier frequency interferograms of two wavelengths on the same camera. Through computational processing, high-precision chromatic aberration compensation for dual-wavelength synthetic phase measurement can be achieved within a low-cost optical system.

### SUMMARY

One or more embodiments of the present disclosure provide a method for chromatic aberration compensation in dual-wavelength digital holography. The method includes: obtaining a dual-wavelength interferogram simultaneously containing two different wavelengths; receiving the dual-wavelength interferogram and obtaining complex amplitudes of the two wavelengths at a camera plane through calculation; based on the complex amplitudes of the two wavelengths at the camera plane, performing numerical propagation on object wavefronts of the two wavelengths within a set defocus range by using an angular spectrum propagation algorithm, to obtain, for each of the two wavelengths, complex amplitudes at different axial propagation positions within the defocus range; for each of the two wavelengths: calculating, at each of the different axial propagation positions within the defocus range, a single-wavelength phase distribution corresponding to the axial propagation position based on the complex amplitude at the axial propagation position; based on the single-wavelength phase distributions at the different axial propagation positions corresponding to each of the two wavelengths, calculating, for all combinations of different axial propagation positions for the two wavelengths, dual-wavelength synthetic phase distributions; obtaining gradient values of the dual-wavelength synthetic phase distributions when the two wavelengths are at the different axial propagation positions by calculating gradients for all the dual-wavelength synthetic phase distributions; and obtaining a chromatic-aberration-compensated dual-wavelength synthetic phase by identifying a combination of axial propagation positions at which the gradient value of the corresponding dual-wavelength synthetic phase distribution reaches a minimum among all the dual-wavelength synthetic phase distributions, and subtracting two single-wavelength phases corresponding to the identified combination of axial propagation positions.

In some embodiments, the defocus range is set as D=d₁˜d_{M}=4 mm, where D denotes the defocus range, d denotes an imaging plane distance, and M denotes a natural number.

In some embodiments, the method further includes: performing, for each of the two wavelengths, a two-dimensional Fourier transform on an initial complex amplitude of an optical field of the wavelength and converting the initial complex amplitude into a frequency domain; introducing a phase factor related to a propagation distance into the frequency domain to represent an influence of different propagation distances, and performing an inverse Fourier transform to return to a spatial domain to obtain object complex amplitudes

$${U}_{{d}_{m}}^{{λ}_{1}} and {U}_{{d}_{n}}^{{λ}_{2}}$$

at different defocused planes:

$${U}_{{d}_{m}}^{{λ}_{1}} = {F}^{- 1} \{ F \{ {U}_{0}^{{λ}_{1}} \} \cdot exp [ j \frac{2 π}{{λ}_{1}} {d}_{m} \sqrt{1 - {( {λ}_{1} u )}^{2} - {( {λ}_{1} v )}^{2}} ] \} ,$$

$${U}_{{d}_{n}}^{{λ}_{2}} = {F}^{- 1} \{ F \{ {U}_{0}^{{λ}_{2}} \} \cdot exp [ i \frac{2 π}{{λ}_{2}} {d}_{n} \sqrt{1 - {( {λ}_{2} u )}^{2} - {( {λ}_{2} v )}^{2}} ] \} ,$$

wherein

$${U}_{0}^{{λ}_{1}}$$

denotes complex amplitudes of a wavelength λ₁ at the different axial propagation positions within the defocus range;

$${U}_{0}^{{λ}_{2}}$$

denotes complex amplitudes of a wavelength λ₂ at the different axial propagation positions within the defocus range; F{ } denotes the Fourier transform; F⁻¹{ } denotes the inverse Fourier transform; (u,v) denotes frequency domain coordinates corresponding to spatial coordinates; and subscripts m, n=1, 2, . . . , M denote propagation position indices.

In some embodiments, the propagation position indices satisfy:

$$M = floor [ ( {d}_{m} - {d}_{0} ) / step ] + 1 ,$$

wherein floor denotes a floor function, and M=41.

In some embodiments, the method further includes: subtracting the single-wavelength phase distributions of the wavelength λ₂ at all the different axial propagation positions from each single-wavelength phase distribution of the wavelength λ₁ to obtain M² dual-wavelength synthetic phase distributions φ_{m,n}.

$${φ}_{m , n} = {φ}_{{d}_{m}}^{{λ}_{1}} - {φ}_{{d}_{n}}^{{λ}_{2}} ,$$

wherein

$${φ}_{{d}_{m}}^{{λ}_{1}}$$

denotes the single-wavelength phase distribution corresponding to the wavelength λ₁, and

$${φ}_{{d}_{n}}^{{λ}_{2}}$$

denotes the single-wavelength phase distribution corresponding to the wavelength.

In some embodiments, the method further includes: calculating gradient values for all the dual-wavelength synthetic phase distributions φ_{m,n} to obtain the gradient values G_{m,n} of the dual-wavelength synthetic phase distributions when the two wavelengths are at the different axial propagation positions m, n:

$${G}_{m , n} = {\sum }_{x = 2}^{X} {\sum }_{y = 2}^{Y} \sqrt{{( {φ}_{m , n} ( x , y ) - {φ}_{m , n} ( x - 1 , y ) )}^{2} + {( {φ}_{m , n} ( x , y ) - {φ}_{m , n} ( x , y - 1 ) )}^{2}} ,$$

wherein X, Y denote a count of pixels of an image along a longitudinal direction and a transverse direction, respectively.

In some embodiments, the method further includes: constructing a first propagation sequence based on the complex amplitudes of the two wavelengths at the camera plane and a first preset step size; determining a second propagation sequence based on a propagation result of the first propagation sequence; and performing angular spectrum propagation within the second propagation sequence based on a second preset step size, wherein the first preset step size is greater than the second preset step size.

In some embodiments, the method further includes: for each of the two wavelengths at each of the different axial propagation positions, calculating an amplitude statistic corresponding to the wavelength at a corresponding axial propagation position based on a complex amplitude distribution of the wavelength at the corresponding axial propagation position; for each combination of an axial propagation position for the first wavelength and an axial propagation position for the second wavelength, calculating a comprehensive evaluation value for the combination based on the amplitude statistic corresponding to the axial propagation position for the first wavelength, the amplitude statistic corresponding to the axial propagation position for the second wavelength, and a gradient value of a dual-wavelength synthetic phase distribution corresponding to the combination; and determining a combination of axial propagation positions for obtaining a chromatic-aberration-compensated dual-wavelength synthetic phase based on the comprehensive evaluation value for each combination of propagation positions, wherein the determined axial propagation positions are within a defocus range corresponding to the second propagation sequence.

In some embodiments, the method further includes: performing three-dimensional reconstruction on a surface morphology of a sample under test based on the chromatic-aberration-compensated dual-wavelength synthetic phase to obtain a three-dimensional reconstruction result; and sending a first control signal to a display device of a digital holography system based on the three-dimensional reconstruction result, wherein the first control signal instructs the display device to display the three-dimensional reconstruction result.

One or more embodiments of the present disclosure further provide a system for chromatic aberration compensation in dual-wavelength digital holography. The system includes: a first laser light source, continuously emitting a first initial light beam; a second laser light source, continuously emitting a second initial light beam; a first beam splitter, disposed in an emission direction common to the first initial light beam and the second initial light beam, for combining the first initial light beam and the second initial light beam to obtain a combined beam; a second beam splitter, disposed in an emission direction of the combined beam, for splitting the combined beam to obtain a first split light beam and a second split light beam; a third beam splitter, disposed in an emission direction of the first split light beam, for splitting the first split light beam to obtain a first modulated incident beam and a second modulated incident beam; a first planar mirror, disposed in an emission direction of the first modulated incident beam, for reflecting the first modulated incident beam to form a first modulated output beam; a second planar mirror, disposed in an emission direction of the second modulated incident beam, for reflecting the second modulated incident beam to form a second modulated output beam, wherein the second modulated output beam and the first modulated output beam are combined in the third beam splitter to form a reference beam which exits the third beam splitter; a fourth beam splitter, disposed in an emission direction of the second split light beam, for transmitting the second split light beam to irradiate a surface of a sample under test, and for reflecting a beam reflected back from the surface of the sample under test again to form an object beam; a fifth beam splitter, disposed in a direction common to the reference beam and the object beam, for combining the reference beam and the object beam to form an interference beam; a camera, disposed in an emission direction of the interference beam, for receiving the interference beam to obtain a dual-wavelength interferogram; and a processor, configured to receive the dual-wavelength interferogram and analyze the dual-wavelength interferogram to obtain a chromatic-aberration-compensated dual-wavelength synthetic phase. The processor includes: an amplitude calculation module, configured to receive the dual-wavelength interferogram and obtain complex amplitudes of two different wavelengths at a camera plane through calculation; an amplitude distribution module, configured to: based on the complex amplitudes of the two wavelengths at the camera plane, perform numerical propagation on object wavefronts of the two wavelengths within a set defocus range by using an angular spectrum propagation algorithm to obtain, for each of the two wavelengths, complex amplitudes at different axial propagation positions within the defocus range; a single-wavelength phase distribution module, configured to: for each of the two wavelengths: calculate, at each of the different axial propagation positions within the defocus range, a single-wavelength phase distribution corresponding to the axial propagation position based on the complex amplitude at the axial propagation position; a dual-wavelength phase distribution module, configured to: based on the single-wavelength phase distributions at the different axial propagation positions corresponding to each of the two wavelengths, calculate, for all combinations of different axial propagation positions for the two wavelengths, dual-wavelength synthetic phase distributions; a gradient calculation module, configured to obtain gradient values of the dual-wavelength synthetic phase distributions when the two wavelengths are at the different axial propagation positions by calculating gradients for all the dual-wavelength synthetic phase distributions; and a chromatic aberration compensation module, configured to: obtain a chromatic-aberration-compensated dual-wavelength synthetic phase by identifying a combination of axial propagation positions at which the gradient value of the corresponding dual-wavelength synthetic phase distribution reaches a minimum among all the dual-wavelength synthetic phase distributions, and subtracting two single-wavelength phases corresponding to the identified combination of axial propagation positions.

In some embodiments, the first planar mirror and the second planar mirror are movable and rotatable; by moving the first planar mirror and the second planar mirror, a beam path length of the reference beam is adjusted to change a focusing distance of the reference beam; and by rotating the first planar mirror and the second planar mirror, an emission direction of the reference beam is changed to enable the interference beam to form an off-axis interference.

In some embodiments, the system further includes a first polarizer and a second polarizer. The first polarizer is disposed between the first planar mirror and the third beam splitter to filter out a beam component containing a wavelength of the second laser light source from the first modulated incident beam. The second polarizer is disposed between the second planar mirror and the third beam splitter to filter out a beam component containing a wavelength of the first laser light source from the second modulated incident beam.

For better understanding and implementation, a method for chromatic aberration compensation in dual-wavelength digital holography provided by the present disclosure is described in detail below with reference to the accompanying drawings.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating an exemplary structure of a system for chromatic aberration compensation in dual-wavelength digital holography according to some embodiments of the present disclosure.

FIG. 2 is a flowchart illustrating an exemplary process of a method for chromatic aberration compensation in dual-wavelength digital holography according to some embodiments of the present disclosure.

FIG. 3 is a schematic diagram illustrating an exemplary structure of a processor in the system for chromatic aberration compensation in dual-wavelength digital holography described in FIG. 1.

FIG. 4 is a schematic diagram of gradient value images of dual-wavelength synthetic phase distributions at all combinations of axial propagation positions in the method for chromatic aberration compensation in dual-wavelength digital holography described in FIG. 2.

FIG. 5 is a set of schematic diagrams illustrating phase distributions of two wavelengths in focus at a position of a minimum gradient value of a dual-wavelength synthetic phase distribution in the method for chromatic aberration compensation in dual-wavelength digital holography described in FIG. 2, wherein (a) shows a phase distribution corresponding to a wavelength λ₁=532 nm, and (b) shows a phase distribution corresponding to a wavelength λ₂=639 nm.

FIG. 6 is a set of comparative schematic diagrams illustrating measurement results of a dual-wavelength synthetic phase of a step object obtained by the method for chromatic aberration compensation in dual-wavelength digital holography described in FIG. 2 and conventional measurement results without chromatic aberration compensation, wherein (a) shows a dual-wavelength measurement phase distribution without chromatic aberration compensation, (b) shows a cross-sectional profile of (a) along a step direction, (c) shows a chromatic aberration-compensated dual-wavelength measurement phase distribution, and (d) shows a cross-sectional profile of (c) along the step direction.

### DETAILED DESCRIPTION

To address the chromatic aberration problem, existing manners include improvements in optical systems, incorporation of achromatic elements, or compensation using numerical processing techniques. For example, Indian scholar Ibrahim improved the optical system by using two identical cameras and two bandpass filters to capture two holograms in real time. However, this manner essentially uses two Mach-Zehnder interferometers, which increases the complexity of the system. Additionally, because two cameras are required for simultaneous measurement, the difficulty of experimental debugging and the requirement for camera matching are also increased.

Furthermore, incorporating achromatic elements such as achromatic lenses into the optical system can reduce the focal point differences for different wavelengths to some extent. However, the manufacturing cost of these optical elements is high, and the design difficulty is increased in complex optical systems. In practical applications, due to manufacturing tolerances in optical components and the non-ideal nature of experimental setups, chromatic aberration is difficult to eliminate entirely, a problem further exacerbated by complex optical systems.

For employing numerical processing, these involve post-processing the recorded interferograms using computational algorithms to eliminate or reduce the impact of chromatic aberration on measurement accuracy. For example, scholar Ferraro from Italy proposed numerical refocusing of the defocused wavelength in the hologram, positing that compensated chromatic aberration would result in the absence of circular fringes in the final phase map. However, this method requires prior knowledge of at least the corresponding defocus distance for one wavelength. Furthermore, in dynamically changing experiments, determining the optimal focus state for the object at different wavelengths relies on visual inspection, which is prone to misjudging the focal plane and thus affects the accuracy of phase measurement. Moreover, most existing chromatic aberration compensation methods are designed for single-wavelength digital holography scenarios and are not directly applicable in dual-wavelength digital holography compensation.

In summary, existing techniques for chromatic aberration compensation in dual-wavelength digital holography still have problems such as system complexity, high manufacturing cost, or inaccurate measurement. To this end, the present disclosure provides a refocusing criterion suitable for dual wavelengths, enabling simultaneous refocusing of the two wavelengths, thereby eliminating chromatic aberration.

To make the objectives, technical solutions, and advantages of the embodiments in the present disclosure clearer, the technical solutions in the embodiments of the present disclosure are described in detail below with reference to the accompanying drawings in the embodiments of the present disclosure. Obviously, the described embodiments are part of the embodiments of the present disclosure, not all of the embodiments.

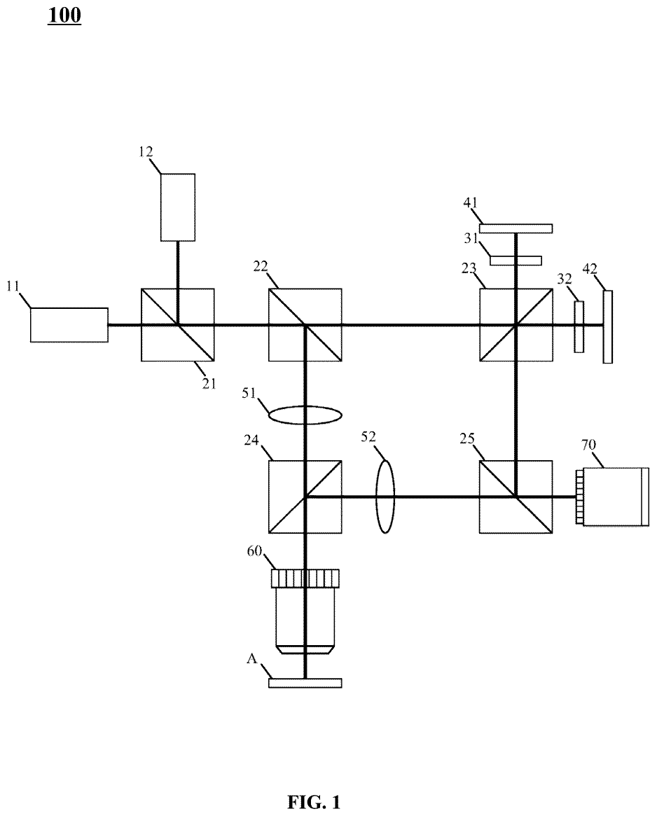

FIG. 1 is a schematic diagram illustrating an exemplary structure of a system for chromatic aberration compensation in dual-wavelength digital holography according to some embodiments of the present disclosure.

Referring to FIG. 1, a system 100 for chromatic aberration compensation in dual-wavelength digital holography (also referred to as the system 100 or the chromatic aberration compensation method 100) includes a first laser light source 11, a second laser light source 12, a first beam splitter 21, a second beam splitter 22, a third beam splitter 23, a fourth beam splitter 24, a fifth beam splitter 25, a first polarizer 31, a second polarizer 32, a first planar mirror 41, a second planar mirror 42, a first tube lens 51, a second tube lens 52, an objective lens 60, a camera 70, and a processor (not shown in FIG. 1).

The first laser light source 11 continuously emits a first initial light beam. The second laser light source 12 continuously emits a second initial light beam. The first initial light beam and the second initial light beam have different wavelengths. The first beam splitter 21 is disposed in a direction common to the first initial light beam emitted from the first laser light source 11 and the second initial light beam emitted from the second laser light source 12. The first initial light beam and the second initial light beam are perpendicular. It should be understood that the positions of the first laser light source 11 and the second laser light source 12 are interchangeable. The specific types and models of the two light sources are not limited, as long as the light beams emitted by the first laser light source 11 and the second laser light source 12 have different wavelengths. The first beam splitter 21 is a conventional beam splitter, which transmits a light beam with a portion of energy of the first initial light beam and reflects a light beam with the remaining portion of energy of the second initial light beam. It should be understood that when the positions of the first laser light source 11 and the second laser light source 12 are interchanged, the first beam splitter 21 reflects a light beam with a portion of the energy of the first initial light beam and transmits a light beam with the remaining portion of the energy of the second initial light beam, as long as the first initial light beam and the second initial light beam are combined.

The second beam splitter 22 is disposed in an emission direction of a combined beam from the first beam splitter 21. The second beam splitter 22 may split the light beam from the first beam splitter 21 to obtain a first split light beam and a second split light beam. The third beam splitter 23 is disposed in an emission direction of the first split light beam. The fourth beam splitter 24 is disposed in an emission direction of the second split light beam. The second beam splitter 22 is a conventional beam splitter, splitting the light beam from the first beam splitter 21 at an energy ratio.

The third beam splitter 23 is disposed in the emission direction of the first split light beam and splits the first split light beam to obtain a first modulated incident beam and a second modulated incident beam. The first planar mirror 41 is disposed in an emission direction of the first modulated incident beam. The first polarizer 31 is disposed between the first planar mirror 41 and the third beam splitter 23. The second planar mirror 42 is disposed in an emission direction of the second modulated incident beam. The second polarizer 32 is disposed between the second planar mirror 42 and the third beam splitter 23. The third beam splitter 23 is a conventional beam splitter, splitting the incident beam at an energy ratio. The first polarizer 31 filters out a beam component containing a wavelength of the second laser light source 12 from the first modulated incident beam. The second polarizer 32 filters out a beam component containing a wavelength of the first laser light source 11 from the second modulated incident beam.

In some embodiments, the first planar mirror 41 and the second planar mirror 42 are movable and rotatable. By rotating, an emission direction of the reference beam may be changed.

Another output beam from the second beam splitter 22 after splitting irradiates a surface of a sample under test A. The fourth beam splitter 24 is disposed between the second beam splitter 22 and the sample under test A. The first tube lens 51 is disposed between the fourth beam splitter 24 and the second beam splitter 22. The objective lens 60 is disposed between the fourth beam splitter 24 and the sample under test A. The second tube lens 52 is disposed in an emission direction of an object beam to focus the object beam.

The fifth beam splitter 25 is disposed in a direction common to the reference beam from the third beam splitter 23 and the object beam from the fourth beam splitter 24. The fifth beam splitter 25 combines the reference beam and the object beam to form an interference beam. The camera 70 is disposed in an emission direction of the interference beam. Similarly, the fourth beam splitter 24 and the fifth beam splitter 25 are both conventional beam splitters, splitting the incident beam at an energy ratio.

The processor is connected to the camera. The processor receives a dual-wavelength interferogram simultaneously containing wavelengths λ₁ and λ₂ and analyzes the dual-wavelength interferogram to obtain a chromatic-aberration-compensated dual-wavelength synthetic phase. In some embodiments, the wavelength of the first laser light source 11 is λ₁=532 nm. The wavelength of the second laser light source 12 is λ₂=639 nm. The first planar mirror 41 and the second planar mirror 42 are adjusted so that the interferograms of the two wavelengths are orthogonal in a carrier frequency direction and are simultaneously received by the camera 70, resulting in a dual-wavelength interferogram containing orthogonal spatial carrier frequency interference fringes of the dual wavelengths. The chromatic-aberration-compensated dual-wavelength synthetic phase is obtained by analyzing the dual-wavelength interferogram.

The chromatic-aberration-compensated dual-wavelength synthetic phase refers to a synthetic phase from which a difference in focal plane positions (i.e., axial chromatic aberration) caused by different wavelengths has been eliminated. Compared to a synthetic phase directly calculated at a single fixed plane (e.g., a camera plane), the chromatic-aberration-compensated dual-wavelength synthetic phase can more accurately reflect the surface morphology of an object.

The beam propagation process in the system 100 of the present disclosure is specifically described below.

The first laser light source 11 emits a first initial light beam. The second laser light source 12 emits a second initial light beam. The first beam splitter 21 receives the first initial light beam and the second initial light beam and combines the first initial light beam and the second initial light beam to form a combined beam. The combined beam transmits through the second beam splitter 22 to form a first split light beam, and the combined beam is reflected by the second beam splitter 22 to form a second split light beam.

The first split light beam is incident on the third beam splitter 23 and is reflected by the third beam splitter 23 to form a first modulated incident beam. The first modulated incident beam transmits through the first polarizer 31 to form a first filtered beam. The first filtered beam irradiates the first planar mirror 41, is reflected by the first planar mirror 41, and transmits through the first polarizer 31 again to form a first modulated output beam. The first split light beam transmits through the third beam splitter 23 to form a second modulated incident beam. The second modulated incident beam transmits through the second polarizer 32 to form a second filtered beam. The second filtered beam irradiates the second planar mirror 42, is reflected by the second planar mirror 42, and transmits through the second polarizer 32 again to form a second modulated output beam. The third beam splitter 23 receives the first modulated output beam and the second modulated output beam and combines the first modulated output beam and the second modulated output beam to form a reference beam exiting the third beam splitter 23.

The second split light beam passes through the first tube lens 51 and is converged. The converged second split light beam is incident on the fourth beam splitter 24 and transmits through the fourth beam splitter 24 to form an observation beam. The observation beam passes through the objective lens 60 and irradiates the surface of the sample under test A. The observation beam is reflected to form an information beam containing surface information of the sample under test A. The information beam propagates in the reverse direction of the observation beam. The information beam is collimated by the objective lens 60 and is reflected by the fourth beam splitter 24 to form an object beam. The object beam is focused again by the second tube lens 52.

The fifth beam splitter 25 receives the reference beam and the object beam and combines the reference beam and the object beam to form an interference beam. The camera 70 receives the interference beam to obtain a dual-wavelength interferogram. The dual-wavelength interferogram simultaneously contains beam components of different wavelengths emitted by the first laser light source 11 and the second laser light source 12.

The processor receives the dual-wavelength interferogram simultaneously containing two wavelengths and analyzes the dual-wavelength interferogram to obtain the chromatic-aberration-compensated dual-wavelength synthetic phase.

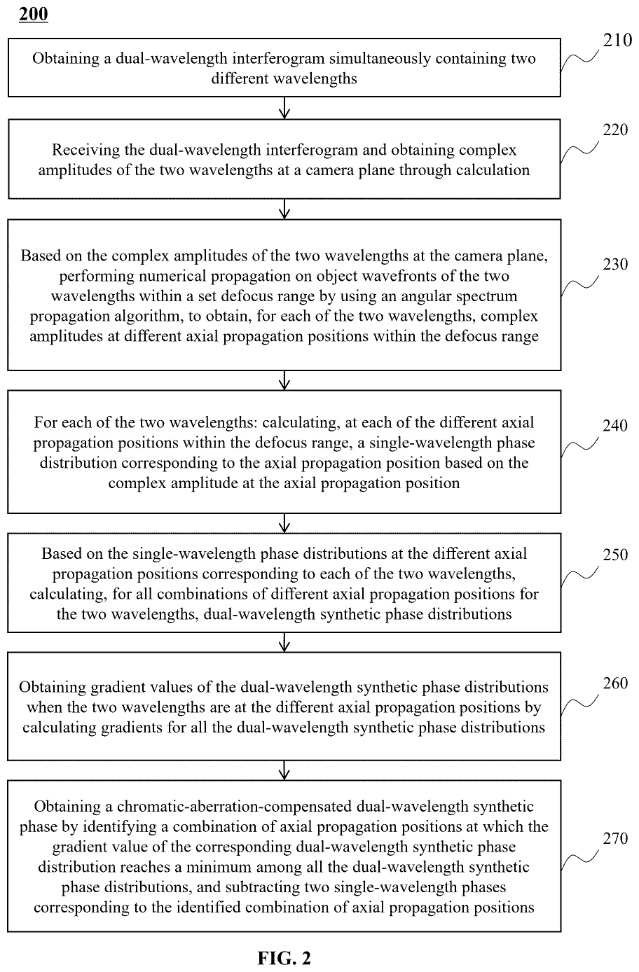

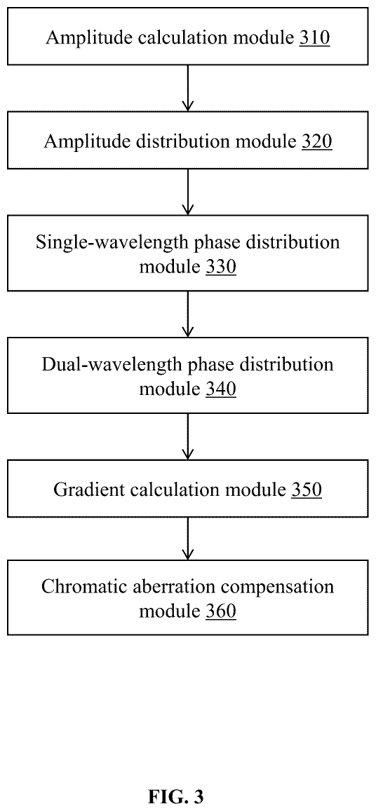

FIG. 2 is a flowchart illustrating an exemplary process of a method for chromatic aberration compensation in dual-wavelength digital holography according to some embodiments of the present disclosure. FIG. 3 is a schematic diagram illustrating an exemplary structure of a processor in the system for chromatic aberration compensation in dual-wavelength digital holography described in FIG. 1.

Referring to FIG. 2 and FIG. 3, a process 200 shown in FIG. 2 may include operations 210-270. The process 200 may be performed by the system 100 for chromatic aberration compensation in dual-wavelength digital holography.

In 210, a dual-wavelength interferogram simultaneously containing two wavelengths is obtained.

In some embodiments, operation 210 may be implemented based on the system 100 for chromatic aberration compensation in dual-wavelength digital holography. In some embodiments, a camera may receive an interference beam formed by a fifth beam splitter to obtain a dual-wavelength interferogram. For this part, reference may be made to the beam propagation process of the system 100 for chromatic aberration compensation in dual-wavelength digital holography described in FIG. 1 above.

In some embodiments, operations 220-270 may be implemented by a processor of the system 100 for chromatic aberration compensation in dual-wavelength digital holography.

As shown in FIG. 3, the processor includes an amplitude calculation module 310, an amplitude distribution module 320, a single-wavelength phase distribution module 330, a dual-wavelength phase distribution module 340, a gradient calculation module 350, and a chromatic aberration compensation module 360.

In 220, the dual-wavelength interferogram is received and complex amplitudes of the two wavelengths at a camera plane are obtained through calculation. In some embodiments, operation 220 may be implemented by the amplitude calculation module 310.

The amplitude calculation module 310 refers to a module configured to perform calculations on the received dual-wavelength interferogram to obtain the complex amplitudes of the two wavelengths at the camera plane.

In some embodiments, the amplitude calculation module 310 is configured to calculate, using a Fourier transform method, the complex amplitudes

$${U}_{0}^{{λ}_{1}} , {U}_{0}^{{λ}_{2}}$$

and the corresponding single-wavelength phases

$${φ}_{0}^{{λ}_{1}} , {φ}_{0}^{{λ}_{2}}$$

of the two wavelengths at the camera plane from the received dual-wavelength interferogram.

The camera plane (also referred to as a hologram recording plane) refers to a physical plane where the photosensitive surface of an image acquisition device (e.g., the camera) is located. Physically, the object beam and the reference beam interfere at the camera plane to form the dual-wavelength interferogram. In numerical propagation calculations, the camera plane is typically defined as a starting position for numerical propagation (e.g., setting the propagation distance d=0) or a starting position for an angular spectrum propagation algorithm.

Numerical propagation refers to a process of simulating the evolution of an object wavefront of a light wave along an optical axis direction in free space using a computer algorithm based on scalar diffraction theory.

The complex amplitude refers to a complex physical quantity characterizing a vibration state of a light wave at a point in an optical field. The square of the modulus of the complex amplitude of a light wave at a point is proportional to the light intensity at the point. The argument of the complex amplitude characterizes the phase of the light wave.

In 230, based on the complex amplitudes of the two wavelengths at the camera plane, numerical propagation is performed on object wavefronts of the two wavelengths within a set defocus range by using an angular spectrum propagation algorithm, to obtain, for each of the two wavelengths, complex amplitudes at different axial propagation positions within the defocus range. In some embodiments, operation 230 may be performed by the amplitude distribution module 320.

It should be noted that, as used in the embodiments of the present disclosure, the terms “axial position,” “axial propagation position,” and “propagation position” have the same meaning.

The amplitude distribution module 320 refers to a module configured to perform a numerical propagation calculation to obtain the complex amplitude of a wavelength at an axial propagation position.

Through repeated experiments, it is observed that defocus distances of two-wavelength imaging on the camera plane in the dual-wavelength digital holography system of the present disclosure are both within +2 mm. Therefore, in the dual-wavelength digital holography system, the defocus range for the two wavelengths is uniformly set as D=d₁˜d_{M}=4 mm, and with a step size of step=0.1 mm, the complex amplitude at each propagation position is calculated stepwise from a camera plane distance d₁=−2 mm to d_{M}=2 mm, where M is a natural number.

The defocus range refers to a spatial range covered by the processor performing numerical propagation calculations (e.g., calculations using the angular spectrum propagation algorithm) for different propagation distances along the optical axis direction in a numerical reconstruction process. Within the defocus range, the processor may find an optimal axial propagation position that achieves optimal quality of a reconstructed image by using the angular spectrum propagation algorithm. The defocus range may be a symmetric or asymmetric interval centered on the camera plane (d=0) along the optical axis direction. For example, the defocus range may be [−2 mm, 2 mm], [−5 mm, 5 mm], [0, 10 mm], etc.

In some embodiments, the amplitude distribution module 320 may be configured to perform numerical propagation on the object wavefronts of the two wavelengths within the defocus range D by using the angular spectrum propagation algorithm, to obtain, for each of the two wavelengths, the complex amplitudes at different axial propagation positions within the defocus range D.

The angular spectrum propagation algorithm is a numerical calculation technique based on scalar diffraction theory. In some embodiments, the angular spectrum propagation algorithm is used to simulate the propagation process of light waves in free space. The angular spectrum propagation algorithm calculates a complex amplitude distribution for an optical field propagating from one plane to another parallel plane by multiplying, in a frequency domain, a transfer function (a phase factor) related to a propagation distance. Compared with other diffraction algorithms (e.g., the Fresnel diffraction integral), the angular spectrum propagation algorithm has higher accuracy in short-distance propagation and near-field diffraction calculations, and does not introduce phase errors due to paraxial approximation. Therefore, the angular spectrum propagation algorithm is suitable for precise chromatic aberration compensation calculations for small defocus distances (e.g., on the order of millimeters) in the present disclosure.

In some embodiments, a two-dimensional Fourier transform is performed on an initial complex amplitude of the optical field of each of the two wavelengths and converting the initial complex amplitude into a frequency domain. A phase factor related to the propagation distance is introduced into the frequency domain to represent the influence of different propagation distances. An inverse Fourier transform is performed to return to a spatial domain to obtain object complex amplitudes

$${U}_{{d}_{m}}^{{λ}_{1}} and {U}_{{d}_{n}}^{{λ}_{2}}$$

at different defocused planes:

$${U}_{{d}_{m}}^{{λ}_{1}} = {F}^{- 1} \{ F \{ {U}_{0}^{{λ}_{1}} \} \cdot exp [ j \frac{2 π}{{λ}_{1}} {d}_{m} \sqrt{1 - {( {λ}_{1} u )}^{2} - {( {λ}_{1} v )}^{2}} ] \} ,$$

$${U}_{{d}_{n}}^{{λ}_{2}} = {F}^{- 1} \{ F \{ {U}_{0}^{{λ}_{2}} \} \cdot exp [ i \frac{2 π}{{λ}_{2}} {d}_{n} \sqrt{1 - {( {λ}_{2} u )}^{2} - {( {λ}_{2} v )}^{2}} ] \} .$$

In the above formulas, λ₁ and λ₂ denote wavelengths of a first laser light source and a second laser light source, respectively; dₘ and dₙ denote propagation distances of the two wavelengths, respectively, which are known system parameters predetermined; F{ } denotes the dimensional Fourier transform, F⁻¹{ } denotes the inverse Fourier transform, and both are performed by the processor calling a fast Fourier transform (FFT) algorithm;

$${U}_{0}^{{λ}_{1}}$$

denotes the initial complex amplitude of the wavelength of the first laser light source at the camera plane (i.e., d=0),

$${U}_{0}^{{λ}_{2}}$$

denotes the initial complex amplitude of the wavelength of the second laser light source at the camera plane (i.e., d=0), and the initial complex amplitudes are obtained by demodulation of a collected dual-wavelength interferogram by the amplitude calculation module 310; (u,v) denote frequency domain coordinates corresponding to spatial coordinates, and are determined by the processor based on a pixel size and a sampling resolution of the camera; subscripts m, n=1, 2, . . . , M denote propagation position indices, and are determined by dividing a total length of the defocus range by the step size and rounding down to the nearest integer.

In 240, for each of the two wavelengths: calculating, at each of the different axial propagation positions within the defocus range, a single-wavelength phase distribution corresponding to the axial propagation position based on the complex amplitude at the axial propagation position. In some embodiments, operation 240 may be performed by the single-wavelength phase distribution module 330.

The single-wavelength phase distribution module 330 refers to a model configured to extract phase information from complex amplitudes.

For the defocus range D=4 mm, a range of 2 mm forward and backward along the optical axis from an initial position is selected. That is to say, with the original hologram acquisition position set as 0 mm, the complex amplitudes for the two wavelengths are calculated starting from d₁=−2 mm to d_{M}=2 mm at intervals defined by the step size step=0.1 mm. Complex amplitude distributions

$${U}_{{d}_{1}}^{{λ}_{1}} ∼ {U}_{{d}_{M}}^{{λ}_{1}} and {U}_{{d}_{1}}^{{λ}_{2}} ∼ {U}_{{d}_{M}}^{{λ}_{2}}$$

at M positions are obtained for the two wavelengths. The single-wavelength phase distribution module 330 is configured to calculate the single-wavelength phase distributions

$${φ}_{{d}_{1}}^{{λ}_{1}} ∼ {φ}_{{d}_{M}}^{{λ}_{1}} and {φ}_{{d}_{1}}^{{λ}_{2}} ∼ {φ}_{{d}_{M}}^{{λ}_{2}}$$

corresponding to the complex amplitude at each position. M=floor[(dₘ−d₀)/step]+1 (i.e., M=floor[(dₘ−d₁)/step]+1), where floor denotes a floor function (e.g., rounding down), and in this case, M=41.

The single-wavelength phase distribution refers to a spatial phase distribution of an optical field at a given wavelength on a fixed propagation plane (e.g., the aforementioned camera plane). In other words, the single-wavelength phase distribution is a phase mapping of the wavefront on the fixed propagation plane. In some embodiments, the single-wavelength phase distribution reflects phase information of the optical field at a specified axial propagation position. For example, the single-wavelength phase distribution may be represented as a two-dimensional matrix, and each element in the matrix corresponds to the phase value (typically between −π and π) of a pixel point.

In 250, based on the single-wavelength phase distributions at the different axial propagation positions corresponding to each of the two wavelengths, dual-wavelength synthetic phase distributions may be calculated for all combinations of different axial propagation positions for the two wavelengths. In some embodiments, operation 250 may be performed by the dual-wavelength phase distribution module 340.

The dual-wavelength phase distribution module 340 refers to a module configured to calculate the dual-wavelength synthetic phase distributions.

In some embodiments, the dual-wavelength phase distribution module 340 is configured to calculate dual-wavelength synthetic phase distributions for all combinations of different axial propagation positions for the two wavelengths. The dual-wavelength synthetic phase refers to an equivalent phase distribution generated by performing mathematical operations (e.g., subtraction) on the single-wavelength phase distributions of two different wavelengths (e.g., λ₁ and λ₂). In some embodiments, the dual-wavelength synthetic phase distribution corresponds to a longer synthetic wavelength (Λ=λ₁λ₂/|λ₁−λ₂|). For example, when the two wavelengths are 532 nm and 639 nm, respectively, the synthetic wavelength is approximately 3.18 μm. In some embodiments, the dual-wavelength synthetic phase is obtained by performing pixel-by-pixel subtraction on the two single-wavelength phases.

In some embodiments, the dual-wavelength phase distribution module 340 may subtract the single-wavelength phase distributions of the wavelength 12 at all the different axial propagation positions from each single-wavelength phase distribution of the wavelength λ₁ to obtain M² dual-wavelength synthetic phase distributions φ_{m,n}:

$${φ}_{m , n} = {φ}_{{d}_{m}}^{{λ}_{1}} - {φ}_{{d}_{n}}^{{λ}_{2}} .$$

In the above formula, λ₁ and λ₂ denote the wavelengths of the first laser light source and the second laser light source, respectively; dₘ and dₙ denote the propagation distances of the two wavelengths, respectively, which are known system parameters predetermined;

$${φ}_{{d}_{m}}^{{λ}_{1}}$$

denotes the single-wavelength phase distribution of the wavelength λ₁ at a propagation distance dₘ (i.e., an axial propagation position d=dₘ),

$${φ}_{{d}_{n}}^{{λ}_{2}}$$

denotes the single-wavelength phase distribution of the wavelength λ₂ at a propagation distance dₙ (i.e., an axial propagation position d=dₙ). The single-wavelength phase distributions are obtained by the aforementioned single-wavelength phase distribution module 330.

In 260, gradient values of the dual-wavelength synthetic phase distributions when the two wavelengths are at the different axial propagation positions are obtained by calculating gradient values for all the dual-wavelength synthetic phase distributions. In some embodiments, operation 260 may be performed by the gradient calculation module 350.

The gradient calculation module 350 refers to a module configured to calculate a gradient value for each dual-wavelength synthetic phase distribution.

In some embodiments, the gradient calculation module 350 may be configured to calculate gradient values for all φ_{m,n} to obtain the gradient values G_{m,n} of the dual-wavelength synthetic phase distributions when the two wavelengths are at different axial propagation positions m and n:

$${G}_{m , n} = {\sum }_{x = 2}^{X} {\sum }_{y = 2}^{Y} \sqrt{{( {φ}_{m , n} ( x , y ) - {φ}_{m , n} ( x - 1 , y ) )}^{2} + {( {φ}_{m , n} ( x , y ) - {φ}_{m , n} ( x , y - 1 ) )}^{2}} .$$

In the above formula, X and Y denote the count of pixels of an image along a longitudinal direction and a transverse direction, respectively; (x,y) are pixel coordinates determined by a pixel arrangement of the camera; φ_{m,n}(x,y) denotes a phase value of the dual-wavelength synthetic phase distribution at the pixel coordinates (x,y), and the phase value is obtained by the dual-wavelength phase distribution module 340.

The gradient value is a statistical indicator used to quantify a smoothness degree of a dual-wavelength synthetic phase distribution image. The magnitude of the gradient value directly reflects a compensation effect of axial chromatic aberration (a smaller gradient value indicates a better compensation effect). The gradient value may serve as a focus metric for determining whether a current propagation distance eliminates the chromatic aberration. In some embodiments, the gradient value may be a sum of squared gradients, a sum of absolute gradients, or other statistical measures reflecting smoothness degree of the entire image.

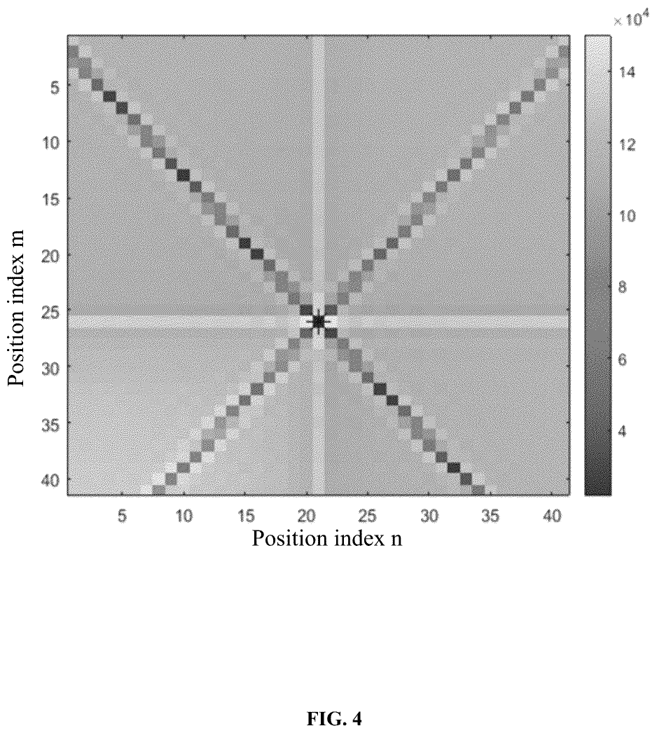

Please refer to FIG. 4. FIG. 4 is a schematic diagram of gradient value images of dual-wavelength synthetic phase distributions at all combinations of axial propagation positions in the method for chromatic aberration compensation in dual-wavelength digital holography described in FIG. 2.

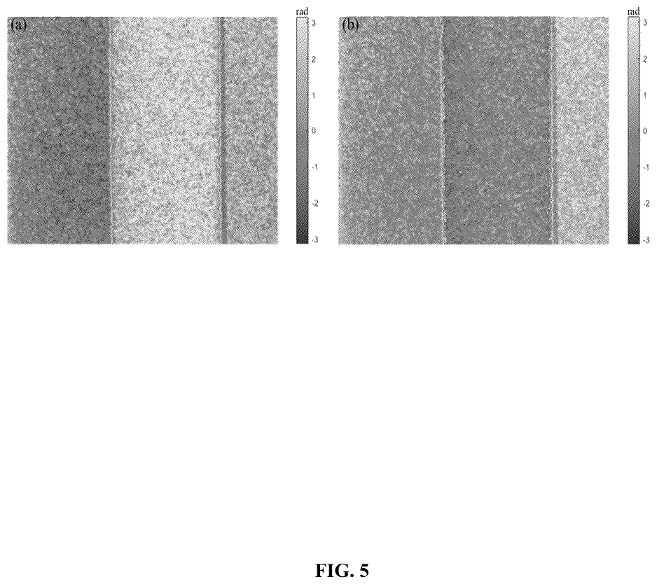

Due to the effect of dispersion, different wavelengths have different refractive indices in the same plane, and thus their focal lengths during focusing also differ. When light waves of two different wavelengths are imaged on the same camera plane, it is impossible to bring the wavefronts of both wavelengths into focus on the camera plane simultaneously. This results in defocusing of the wavefront of one wavelength or both wavelengths, introducing additional phase wraps in the dual-wavelength synthetic phase distribution and consequently increasing the gradient value of the dual-wavelength synthetic phase. Therefore, by identifying the axial propagation positions of the two wavelengths at which the gradient value of the dual-wavelength synthetic phase reaches a minimum, it is possible to determine that the two wavelengths are respectively at their own focal positions. Please refer to FIG. 5. FIG. 5 is a set of schematic diagrams illustrating phase distributions of two wavelengths in focus at a position of a minimum gradient value of a dual-wavelength synthetic phase distribution in the method for chromatic aberration compensation in dual-wavelength digital holography described in FIG. 2, wherein (a) shows a phase distribution corresponding to a wavelength λ₁=532 nm, and (b) shows a phase distribution corresponding to a wavelength λ₂=639 nm.

The axial propagation position (or referred to as a reconstruction distance) refers to a spatial distance position along the optical axis direction relative to the camera plane during numerical propagation. For example, if the camera plane is used as an origin (d=0), and the complex amplitude distribution at an axial propagation position d=1.2 mm is calculated, it means that the processor calculates the complex amplitude distribution at a distance 1.2 mm away from the camera.

In 270, a chromatic-aberration-compensated dual-wavelength synthetic phase may be obtained by identifying a combination of axial propagation positions at which the gradient value of the corresponding dual-wavelength synthetic phase distribution reaches a minimum among all the dual-wavelength synthetic phase distributions, and subtracting two single-wavelength phases corresponding to the identified combination of axial propagation positions. In some embodiments, operation 270 may be performed by the chromatic aberration compensation module 360.

The chromatic aberration compensation module 360 refers to a module configured to obtain the chromatic-aberration-compensated dual-wavelength synthetic phase.

In some embodiments, the chromatic aberration compensation module 360 may be configured to calculate the chromatic-aberration-compensated dual-wavelength synthetic phase. In some embodiments, a minimum value G_{p,q} of G_{m,n} is found. The corresponding subscript index pair (p,q) indicates that when the wavelength λ₁ is at a p-th axial propagation position and the wavelength λ₂ is at a q-th axial propagation position, it corresponds to the optimal propagation distances for the two wavelengths (At this point, the p-th axial propagation position is the optimal axial propagation position for the wavelength λ₁, and the q-th axial propagation position is the optimal axial propagation position for the wavelength λ₂). That is to say,

$${φ}_{{d}_{p}}^{{λ}_{1}} and {φ}_{{d}_{q}}^{{λ}_{2}}$$

are the single-wavelength phase distributions when the two wavelengths are respectively in focus. A dual-wavelength synthetic phase is obtained by locating the single-wavelength phases corresponding to the two indices when each wavelength is in focus and performing subtraction. The dual-wavelength synthetic phase

$${φ}_{p , q} = {φ}_{{d}_{p}}^{{λ}_{1}} - {φ}_{{d}_{q}}^{{λ}_{2}}$$

is the chromatic-aberration-compensated dual-wavelength synthetic phase.

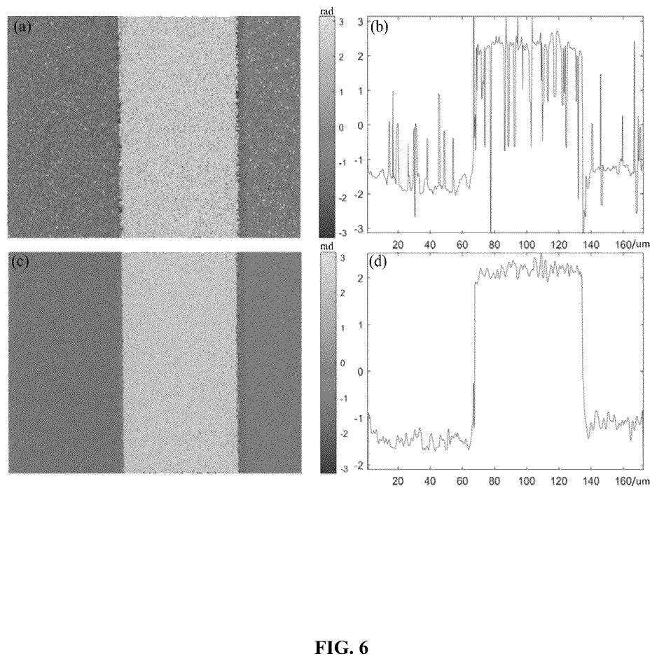

To verify the actual effectiveness of the system 100 for chromatic aberration compensation in dual-wavelength digital holography of the present disclosure, the system 100 is used to measure the dual-wavelength synthetic phase of a step object. Please refer to FIG. 6. FIG. 6 is a set of comparative schematic diagrams illustrating measurement results of a dual-wavelength synthetic phase of a step object obtained by the method for chromatic aberration compensation in dual-wavelength digital holography described in FIG. 2 and conventional measurement results without chromatic aberration compensation, wherein (a) shows a dual-wavelength measurement phase distribution without chromatic aberration compensation; (b) shows a cross-sectional profile of (a) along a step direction; (c) shows a chromatic aberration-compensated dual-wavelength measurement phase distribution; and (d) shows a cross-sectional profile of (c) along the step direction. It should be seen that a dual-wavelength synthetic phase image compensated by the system 100 for chromatic aberration compensation in dual-wavelength digital holography of the present disclosure has a good distribution and stable data fluctuation. The dual-wavelength synthetic phase can be accurately obtained.

In some embodiments, the method for chromatic aberration compensation further includes: constructing a first propagation sequence based on the complex amplitudes of the two wavelengths at the camera plane and a first preset step size; determining a second propagation sequence based on a propagation result of the first propagation sequence; and performing angular spectrum propagation within the second propagation sequence based on a second preset step size, wherein the first preset step size is greater than the second preset step size.

The first preset step size refers to a preset step size for generating axial propagation positions for numerical propagation. The first preset step size may be a distance interval for performing numerical propagation along the optical axis direction of the reference beam. The first preset step size may be preset manually, or automatically determined by the processor proportionally based on a size of an initial search range.

Merely by way of example, the first preset step size may be set to 1.0 mm. In this case, the interval between adjacent axial propagation positions generated is 1.0 mm.

The first propagation sequence refers to a sparse set of axial propagation positions. The first propagation sequence includes a plurality of axial propagation positions arranged in order (i.e., along a positive optical axis direction) from negative defocus distances to positive defocus distances within the defocus range.

In some embodiments, the processor may set an initial search range. Within the initial search range, the processor may take a plurality of propagation position points along the positive optical axis direction at intervals of the first preset step size to form the first propagation sequence. The initial search range refers to an initially preset range for finding optimal axial propagation positions of the two wavelengths. The initial search range may be set based on empirical knowledge. For example, within an initial search range of [−2 mm, 2 mm] and with a first preset step size of 1.0 mm, the constructed first propagation sequence may be {−2, −1, 0, 1, 2} mm.

The propagation result refers to intermediate judgment data obtained by calculation based on the first propagation sequence, used for roughly locating the optimal propagation distance (or optimal axial propagation position).

In some embodiments, for each axial propagation position in the first propagation sequence, the processor may obtain a complex amplitude at the axial propagation position using the angular spectrum propagation algorithm. The processor may use a focusing metric indicator (such as amplitude variance) of these complex amplitudes as the propagation result. More descriptions regarding the angular spectrum propagation algorithm may be found in FIG. 2 and related descriptions thereof.

The second propagation sequence refers to a dense set of axial propagation positions. The second propagation sequence includes a plurality of axial propagation positions arranged along the positive optical axis direction within the defocus range.

In some embodiments, the processor may determine the second propagation sequence based on the propagation result of the first propagation sequence. For example, the processor may calculate an amplitude variance corresponding to each axial propagation position in the first propagation sequence based on the complex amplitudes at the axial propagation positions of the first propagation sequence. The processor may determine an axial propagation position with a largest amplitude variance. The processor may determine a range between two adjacent axial propagation positions before and after the axial propagation position with the largest amplitude variance as a second search range (i.e., an updated search range based on the initial search range).

If the axial propagation position with the largest amplitude variance is the first position or the last position in the first propagation sequence, the processor may determine a range between the axial propagation position with the largest amplitude variance and a preceding adjacent axial propagation position or a following adjacent axial propagation position of the axial propagation position as the second search range.

Within the second search range, the processor may take a plurality of axial propagation positions along the positive optical axis direction at intervals of the second preset step size to form the second propagation sequence. The first preset step size is greater than the second preset step size. The second preset step size may also be preset manually, e.g., 0.5 mm.

Merely by way of example, if the first propagation sequence is {−2, −1, 0, 1, 2} mm, and the processor finds that the amplitude variance corresponding to an axial propagation position of 1 mm is the largest, the processor determines a range between a preceding position (0 mm) and a following position (2 mm) of the 1 mm position as the second search range. Within the second search range of 0 mm to 2 mm, the second propagation sequence is constructed based on the second preset step size of 0.5 mm is {0.0, 0.5, 1.0, 1.5, 2.0} mm.

In some embodiments, performing angular spectrum propagation by the processor based on the second preset step size within the second propagation sequence may refer to: for each axial propagation position in the second propagation sequence, the processor uses the initial complex amplitudes of the two wavelengths at the camera plane as input and performs numerical propagation again using the angular spectrum propagation algorithm to obtain complex amplitudes of the two wavelengths at these dense axial propagation positions. These complex amplitudes may be used for subsequent single-wavelength phase extraction and gradient calculation of the dual-wavelength synthetic phase to ultimately determine precise chromatic aberration compensation positions (i.e., the optimal axial propagation positions of two wavelengths).

In some embodiments, the processor may perform single-wavelength phase extraction based on the single-wavelength phase distribution module 330, perform gradient calculation of the dual-wavelength synthetic phase based on the gradient calculation module 350, and perform determination of chromatic aberration compensation positions based on the chromatic aberration compensation module 360. More descriptions regarding this part may be found in FIG. 2 and related descriptions.

In some embodiments of the present disclosure, through a hierarchical search strategy based on variable step sizes, the system first rapidly screens out a coarse focus position with high contrast from the first propagation sequence using amplitude variance. This avoids performing high-density numerical propagation calculations directly within the larger initial search range, significantly reducing the algorithm's time complexity. Simultaneously, by first identifying a small, high-value second search range and then conducting a fine-grained search, this method can effectively avoid converging to local optima. As a result, it enhances the efficiency and accuracy of phase measurement and chromatic aberration compensation while ensuring computational efficiency.

In some embodiments, the method for chromatic aberration compensation in dual-wavelength digital holography further includes: for each of the two wavelengths at each of the different axial propagation positions, calculating an amplitude statistic corresponding to the wavelength at a corresponding axial propagation position based on a complex amplitude distribution of the wavelength at the corresponding axial propagation position; for each combination of an axial propagation position for the first wavelength and an axial propagation position for the second wavelength, calculating a comprehensive evaluation value for the combination based on the amplitude statistic corresponding to the axial propagation position for the first wavelength, the amplitude statistic corresponding to the axial propagation position for the second wavelength, and a gradient value of a dual-wavelength synthetic phase distribution corresponding to the combination; and determining a combination of axial propagation positions for obtaining a chromatic-aberration-compensated dual-wavelength synthetic phase based on the comprehensive evaluation value for each combination of propagation positions, wherein the determined axial propagation positions are within a defocus range corresponding to the second propagation sequence.

The amplitude statistic refers to a statistic used to quantify the focusing quality of an image. In some embodiments, a larger value of the amplitude statistic indicates a higher image contrast and a better focusing quality.

In some embodiments, the processor may calculate the amplitude statistic corresponding to each axial propagation position for each wavelength based on the complex amplitude distribution of the wavelength at the axial propagation position. Merely by way of example, for a single wavelength (such as λ₁ or λ₂), at each axial propagation position, the processor may extract an amplitude two-dimensional matrix from the complex amplitude distribution corresponding to the wavelength at the axial propagation position. The processor may calculate a standard deviation or a variance of all pixels in the amplitude two-dimensional matrix as the amplitude statistic corresponding to the wavelength at the axial propagation position. Thus, each wavelength has one amplitude statistic at each axial propagation position.

More descriptions regarding the complex amplitude distribution corresponding to each wavelength may be found in FIG. 2 and related descriptions thereof.

The comprehensive evaluation value refers to a single evaluation score obtained by fusing the gradient value of the dual-wavelength synthetic phase distribution and the amplitude statistic. In some embodiments, a higher comprehensive evaluation value indicates a better chromatic aberration compensation effect corresponding to a current combination of axial propagation positions (i.e., closer to the true physical focus state of the two wavelengths).

In some embodiments, the processor may calculate, for each combination of axial propagation positions of the two wavelengths, a comprehensive evaluation value based on the amplitude statistics of the respective wavelengths at their respective propagation positions in the combination, and the gradient value of the dual-wavelength synthetic phase distribution associated with the combination. For example, the processor may perform normalization processing on the amplitude statistics and the gradient value of the dual-wavelength synthetic phase distribution respectively to obtain corresponding standard values, and obtain the comprehensive evaluation value for the combination of axial propagation positions based on the standard values. Normalization techniques may include Min-Max normalization, Z-Score standardization, etc.

Merely by way of example, for a combination of axial propagation positions (i,j) representing the wavelength λ₁ at the axial propagation position i and the wavelength λ₂ at the axial propagation position j, the processor may calculate: a standard value of the amplitude statistic of the wavelength λ₁ at the axial propagation position i, a standard value of the amplitude statistic of the wavelength λ₂ at the axial propagation position j, and a standard value of the gradient value of the dual-wavelength synthetic phase distribution corresponding to the combination of the axial propagation positions (i,j).

In some embodiments, the processor may perform a weighted sum on the three standard values to obtain the comprehensive evaluation value corresponding to the combination of axial propagation positions (i,j). More descriptions regarding calculation of the gradient value of the dual-wavelength synthetic phase distribution may be found in operation 260 of FIG. 2 and related descriptions thereof, which are not repeated here.

In some embodiments, weight coefficients for the weighted sum may be determined by the processor based on a surface texture complexity of the sample under test. Merely by way of example, for a sample with weak texture or a smooth surface, an image contrast is inherently low. Changes in the amplitude statistic may not be obvious and may be easily affected by noise. In this case, the weight coefficient of the gradient value of the dual-wavelength synthetic phase may be increased, and the weight coefficient of the amplitude statistic may be decreased. As another example, for a sample with rich texture or complex structure, image details are sharp and edges are clear, and the amplitude statistic exhibits a pronounced and sharp peak. In this case, the weight coefficient of the amplitude statistic may be appropriately increased.

The sample under test (such as the sample A in FIG. 1) refers to a measurement target placed on an object beam path in the dual-wavelength digital holography system.

In some embodiments, the axial propagation positions are limited to the defocus range corresponding to the second propagation sequence. The processor may select a combination of axial propagation positions with a maximum comprehensive evaluation value. The processor may determine the combination of axial propagation positions with the maximum comprehensive evaluation value as the combination of axial propagation positions for obtaining the chromatic-aberration-compensated dual-wavelength synthetic phase (i.e., a combination including the optimal axial propagation positions for the two wavelengths).

In some embodiments of the present disclosure, by introducing a comprehensive evaluation mechanism that includes variance calculation and bidirectional normalization, the present disclosure effectively addresses the instability of a single gradient metric in specific scenarios (such as weak texture or high noise). By flexibly adjusting the evaluation strategy for samples under test with different texture characteristics (e.g., smooth components or rough surfaces) and leveraging the complementary nature of multi-source information (where amplitude statistics reflect image contrast and the dual-wavelength synthetic phase gradient value reflects chromatic aberration compensation quality), the accuracy and robustness of locking the optimal axial position combination are significantly enhanced.

In some embodiments, the method for chromatic aberration compensation further includes: performing three-dimensional reconstruction on a surface morphology of the sample under test based on the chromatic-aberration-compensated dual-wavelength synthetic phase to obtain a three-dimensional reconstruction result; and sending a first control signal to a display device of a digital holography system based on the three-dimensional reconstruction result, the first control signal instructing the display device to display the three-dimensional reconstruction result.

The surface morphology refers to the three-dimensional geometric shape, undulations, and profile of the surface of the sample under test.

In some embodiments, the processor may perform three-dimensional reconstruction on the surface morphology of the sample under test based on the chromatic-aberration-compensated dual-wavelength synthetic phase to obtain a three-dimensional reconstruction result. For example, the processor may calculate an equivalent wavelength (i.e., an synthetic wavelength) A synthesized from the two wavelengths (wavelength λ₁ and wavelength λ₂) according to the formula Λ=λ₁λ₂/|λ₁−λ₂|; based on the formula h(x,y)=Φ(x,y)×Λ/(4π), the processor converts a phase value of each pixel in the chromatic-aberration-compensated dual-wavelength synthetic phase Φ(x,y) into a physical height value h(x,y).

The processor traverses each pixel in the image, reads a horizontal coordinate and a vertical coordinate (x,y) of the pixel and the calculated height value h(x,y) of the pixel, and outputs a three-dimensional spatial coordinate dataset containing all points (x,y,h(x,y)), i.e., the three-dimensional reconstruction result. x, y are pixel coordinates determined by the pixel arrangement of the camera; Φ(x,y) is the chromatic-aberration-compensated dual-wavelength synthetic phase at the coordinate (x,y), which is calculated and output by the chromatic aberration compensation module 360 in the aforementioned operation 250.

The first control signal refers to an electrical signal for driving the display device to perform image display. In some embodiments, the first control signal is autonomously generated by the processor based on the three-dimensional reconstruction result.

The display device refers to a device capable of presenting a visual image. Merely by way of example, the display device includes a liquid crystal display (LCD), an organic light emitting diode display (OLED), a projector, or the like.

In some embodiments, after receiving the first control signal sent by the processor, the display device may parse and decode the first control signal, and drive pixels on a screen to illuminate to display the three-dimensional reconstruction result of the surface morphology of the sample under test.

In some embodiments, the display device further supports interactive operations, allowing a user to perform various operations on the displayed three-dimensional reconstruction result (e.g., a three-dimensional model), including rotation, zooming, cross-sectional analysis, or the like.

In some embodiments of the present disclosure, by adding three-dimensional reconstruction and the display device, not only is a high-precision chromatic aberration compensation algorithm provided, but a complete technical closed loop from “phase data” to “physical morphology” is further realized. This design transforms abstract mathematical calculation results (e.g., the chromatic-aberration-compensated dual-wavelength synthetic phase) into an intuitive three-dimensional visualization model, enabling the user to directly observe and analyze the microscopic surface morphology of the sample under test (e.g., height undulations at micrometer or nanometer scales), thereby greatly improving the practicality and user experience of the system for chromatic aberration compensation.

The above-described embodiments merely represent optimal implementations of the present disclosure, and the description is relatively specific and detailed, but should not be construed as limiting the scope of the invention patent. It should be pointed out that, for a person of ordinary skill in the art, without departing from the concept of the present disclosure, several modifications and improvements may be made, and the present disclosure is also intended to cover these modifications and variations.

What is claimed is:

1. A method for chromatic aberration compensation in dual-wavelength digital holography, comprising:
obtaining a dual-wavelength interferogram simultaneously containing two different wavelengths;
receiving the dual-wavelength interferogram and obtaining complex amplitudes of the two wavelengths at a camera plane through calculation;
based on the complex amplitudes of the two wavelengths at the camera plane, performing numerical propagation on object wavefronts of the two wavelengths within a set defocus range by using an angular spectrum propagation algorithm, to obtain, for each of the two wavelengths, complex amplitudes at different axial propagation positions within the defocus range;
for each of the two wavelengths: calculating, at each of the different axial propagation positions within the defocus range, a single-wavelength phase distribution corresponding to the axial propagation position based on the complex amplitude at the axial propagation position;
based on the single-wavelength phase distributions at the different axial propagation positions corresponding to each of the two wavelengths, calculating, for all combinations of different axial propagation positions for the two wavelengths, dual-wavelength synthetic phase distributions;
obtaining gradient values of the dual-wavelength synthetic phase distributions when the two wavelengths are at the different axial propagation positions by calculating gradients for all the dual-wavelength synthetic phase distributions;
obtaining a chromatic-aberration-compensated dual-wavelength synthetic phase by identifying a combination of axial propagation positions at which the gradient value of the corresponding dual-wavelength synthetic phase distribution reaches a minimum among all the dual-wavelength synthetic phase distributions, and subtracting two single-wavelength phases corresponding to the identified combination of axial propagation positions;
performing, for each of the two wavelengths, a two-dimensional Fourier transform on an initial complex amplitude of an optical field of the wavelength and converting the initial complex amplitude into a frequency domain; introducing a phase factor related to a propagation distance into the frequency domain to represent an influence of different propagation distances, and performing an inverse Fourier transform to return to a spatial domain to obtain object complex amplitudes
$${U}_{{d}_{m}}^{{λ}_{1}} and {U}_{{d}_{n}}^{{λ}_{2}}$$
at different defocused planes:
$${U}_{{d}_{m}}^{{λ}_{1}} = {F}^{- 1} \{ F \{ {U}_{0}^{{λ}_{1}} \} \cdot exp [ j \frac{2 π}{{λ}_{1}} {d}_{m} \sqrt{1 - {( {λ}_{1} u )}^{2} - {( {λ}_{1} v )}^{2}} ] \} ,$$
$${U}_{{d}_{n}}^{{λ}_{2}} = {F}^{- 1} \{ F \{ {U}_{0}^{{λ}_{2}} \} \cdot exp [ i \frac{2 π}{{λ}_{2}} {d}_{n} \sqrt{1 - {( {λ}_{2} u )}^{2} - {( {λ}_{2} v )}^{2}} ] \} ,$$
wherein
$${U}_{0}^{{λ}_{1}}$$
denotes complex amplitudes of a wavelength λ₁ at the different axial propagation positions within the defocus range;
$${U}_{0}^{{λ}_{2}}$$
denotes complex amplitudes of a wavelength λ₂ at the different axial propagation positions within the defocus range; F{ } denotes the Fourier transform; F⁻¹{ } denotes the inverse Fourier transform; (u,v) denotes frequency domain coordinates corresponding to spatial coordinates; and subscripts m, n=1, 2, . . . , M denote propagation position indices;
the propagation position indices satisfy:
$$M = floor [ ( {d}_{m} - {d}_{0} ) / step ] + 1 ,$$
wherein floor denotes a floor function, and M=41;
subtracting the single-wavelength phase distributions of the wavelength λ₂ at all the different axial propagation positions from each single-wavelength phase distribution of the wavelength λ₁ to obtain M² dual-wavelength synthetic phase distributions φ_{m,n}:
$${φ}_{m , n} = {φ}_{{d}_{m}}^{{λ}_{1}} - {φ}_{{d}_{n}}^{{λ}_{2}} ,$$
wherein
$${φ}_{{d}_{m}}^{{λ}_{1}}$$
denotes the single-wavelength phase distribution corresponding to the wavelength λ₁, and
$${φ}_{{d}_{n}}^{{λ}_{2}}$$
denotes the single-wavelength phase distribution corresponding to the wavelength λ₂; and
calculating gradient values for all the dual-wavelength synthetic phase distributions φ_{m,n} to obtain the gradient values G_{m,n} of the dual-wavelength synthetic phase distributions when the two wavelengths are at the different axial propagation positions m, n:
$${G}_{m , n} = {\sum }_{x = 2}^{X} {\sum }_{y = 2}^{Y} \sqrt{{( {φ}_{m , n} ( x , y ) - {φ}_{m , n} ( x - 1 , y ) )}^{2} + {( {φ}_{m , n} ( x , y ) - {φ}_{m , n} ( x , y - 1 ) )}^{2}} ,$$
wherein X, Y denote a count of pixels of an image along a longitudinal direction and a transverse direction, respectively.

2. The method for chromatic aberration compensation in dual-wavelength digital holography according to claim 1, wherein the defocus range is set as D=d₁˜d_{M}=4 mm, D denotes the defocus range, d denotes an imaging plane distance, and M denotes a natural number.

3. The method for chromatic aberration compensation in dual-wavelength digital holography according to claim 2, further comprising:
constructing a first propagation sequence based on the complex amplitudes of the two wavelengths at the camera plane and a first preset step size;
determining a second propagation sequence based on a propagation result of the first propagation sequence; and
performing angular spectrum propagation within the second propagation sequence based on a second preset step size, wherein the first preset step size is greater than the second preset step size.

4. The method for chromatic aberration compensation in dual-wavelength digital holography according to claim 1, further comprising:
for each of the two wavelengths at each of the different axial propagation positions, calculating an amplitude statistic corresponding to the wavelength at a corresponding axial propagation position based on a complex amplitude distribution of the wavelength at the corresponding axial propagation position;
for each combination of an axial propagation position for the first wavelength and an axial propagation position for the second wavelength, calculating a comprehensive evaluation value for the combination based on the amplitude statistic corresponding to the axial propagation position for the first wavelength, the amplitude statistic corresponding to the axial propagation position for the second wavelength, and a gradient value of a dual-wavelength synthetic phase distribution corresponding to the combination; and
determining a combination of axial propagation positions for obtaining a chromatic-aberration-compensated dual-wavelength synthetic phase based on the comprehensive evaluation value for each combination of propagation positions, wherein the determined axial propagation positions are within a defocus range corresponding to the second propagation sequence.

5. The method for chromatic aberration compensation in dual-wavelength digital holography according to claim 1, further comprising:
performing three-dimensional reconstruction on a surface morphology of a sample under test based on the chromatic-aberration-compensated dual-wavelength synthetic phase to obtain a three-dimensional reconstruction result; and
sending a first control signal to a display device of a digital holography system based on the three-dimensional reconstruction result, wherein the first control signal instructs the display device to display the three-dimensional reconstruction result.

6. A system for chromatic aberration compensation in dual-wavelength digital holography, comprising:
a first laser light source, continuously emitting a first initial light beam;
a second laser light source, continuously emitting a second initial light beam;
a first beam splitter, disposed in an emission direction common to the first initial light beam and the second initial light beam, for combining the first initial light beam and the second initial light beam to obtain a combined beam;
a second beam splitter, disposed in an emission direction of the combined beam, for splitting the combined beam to obtain a first split light beam and a second split light beam;
a third beam splitter, disposed in an emission direction of the first split light beam, for splitting the first split light beam to obtain a first modulated incident beam and a second modulated incident beam;
a first planar mirror, disposed in an emission direction of the first modulated incident beam, for reflecting the first modulated incident beam to form a first modulated output beam;
a second planar mirror, disposed in an emission direction of the second modulated incident beam, for reflecting the second modulated incident beam to form a second modulated output beam, wherein the second modulated output beam and the first modulated output beam are combined in the third beam splitter to form a reference beam which exits the third beam splitter;
a fourth beam splitter, disposed in an emission direction of the second split light beam, for transmitting the second split light beam to irradiate a surface of a sample under test, and for reflecting a beam reflected back from the surface of the sample under test again to form an object beam;
a fifth beam splitter, disposed in a direction common to the reference beam and the object beam, for combining the reference beam and the object beam to form an interference beam;
a camera, disposed in an emission direction of the interference beam, for receiving the interference beam to obtain a dual-wavelength interferogram;
a processor, configured to receive the dual-wavelength interferogram and analyze the dual-wavelength interferogram to obtain a chromatic-aberration-compensated dual-wavelength synthetic phase;
the processor including:
an amplitude calculation module, configured to receive the dual-wavelength interferogram and obtain complex amplitudes of two different wavelengths at a camera plane through calculation;
an amplitude distribution module, configured to: based on the complex amplitudes of the two wavelengths at the camera plane, perform numerical propagation on object wavefronts of the two wavelengths within a set defocus range by using an angular spectrum propagation algorithm to obtain, for each of the two wavelengths, complex amplitudes at different axial propagation positions within the defocus range;
a single-wavelength phase distribution module, configured to: for each of the two wavelengths: calculate, at each of the different axial propagation positions within the defocus range, a single-wavelength phase distribution corresponding to the axial propagation position based on the complex amplitude at the axial propagation position;
a dual-wavelength phase distribution module, configured to: based on the single-wavelength phase distributions at the different axial propagation positions corresponding to each of the two wavelengths, calculate, for all combinations of different axial propagation positions for the two wavelengths, dual-wavelength synthetic phase distributions;
a gradient calculation module, configured to obtain gradient values of the dual-wavelength synthetic phase distributions when the two wavelengths are at the different axial propagation positions by calculating gradients for all the dual-wavelength synthetic phase distributions; and
a chromatic aberration compensation module, configured to: obtain a chromatic-aberration-compensated dual-wavelength synthetic phase by identifying a combination of axial propagation positions at which the gradient value of the corresponding dual-wavelength synthetic phase distribution reaches a minimum among all the dual-wavelength synthetic phase distributions, and subtracting two single-wavelength phases corresponding to the identified combination of axial propagation positions.

7. The system for chromatic aberration compensation in dual-wavelength digital holography according to claim 6, wherein
the first planar mirror and the second planar mirror are movable and rotatable;
by moving the first planar mirror and the second planar mirror, a beam path length of the reference beam is adjusted to change a focusing distance of the reference beam; and
by rotating the first planar mirror and the second planar mirror, an emission direction of the reference beam is changed to enable the interference beam to form an off-axis interference.

8. The system for chromatic aberration compensation in dual-wavelength digital holography according to claim 7, further comprising a first polarizer and a second polarizer; wherein
the first polarizer is disposed between the first planar mirror and the third beam splitter to filter out a beam component containing a wavelength of the second laser light source from the first modulated incident beam; and
the second polarizer is disposed between the second planar mirror and the third beam splitter to filter out a beam component containing a wavelength of the first laser light source from the second modulated incident beam.
